(19) United States
(12) Patent Application Publication
(10) Pub. No.: US 2019/0377805 A1
(43) Pub. Date: Dec. 12, 2019

(54) User Interface for Shared Documents

(71) Applicant: Microsoft Technology Licensing, LLC, Redmond, WA (US)

(72) Inventors: Venkat Pradeep Chilakamarri, Seattle, WA (US); Brian T. Albrecht, Kirkland, WA (US); Rui Hu, Redmond, WA (US); Om Krishna, Redmond, WA (US); Jill K. Larson, Redmond, WA (US)

(21) Appl. No.: 16/003,775

(22) Filed: Jun. 8, 2018

(51) Int. Cl. G06F 17/30; G06F 3/0482

(52) U.S. Cl. CPC G06F 17/30165; G06F 17/30011; G06F 3/0482; G06F 17/30126; G06F 17/3053

(57) ABSTRACT

A method may include receiving a request, from a document authoring application, for a list of documents shared by a user, the request including a user identification; retrieving the list of documents based on the user identification; for each respective document in the list of documents; retrieving an aggregation of views of the respective document by other users within a period of time; retrieving a number of unique viewers of the respective document within the period of time; determining a set of suggested contacts to share the respective document with according to communication signals between the suggested contacts and the user; transmitting, to the document authoring application in response to the request, the list of documents and their respective total views, unique views, and set of suggested contacts for presentation to the user.

### BACKGROUND

User created documents may be stored and shared in a variety of ways. For example, a user may create a document using a document authoring application (e.g., a word processing application). In some instances, the document may only be locally stored on the user's computing device.

In some instances, the user may subscribe to a network-based storage service (sometimes referred to as cloud storage) to backup and sync the user's documents. Any changes made to the document may sync to the network-based storage version of the document and other computing devices of the user. Additionally, the user may edit the document from a web application, in some examples. The user may also share the document with other users. The shared document may viewed or downloaded from the network-based storage device. In some instances, changes made by the creating user may be synced to computing devices of the users that the document has been shared with.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is a schematic diagram illustrating a file sharing system, according to various examples.

FIG. 2 is a user interface diagram illustrating a document authoring application, according to various examples

FIG. 3 is a flowchart representation of a method to present a user interface displaying attention metrics, according to various examples.

FIG. 4 is a flowchart representation of a method to retrieve attention metrics and suggested sharing contacts for a document, according to various examples.

FIG. 5 is a block diagram illustrating an example machine upon which any one or more of the techniques (e.g., methodologies) discussed herein may be performed, according to an example embodiment.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

Throughout this disclosure, electronic actions may be taken by components in response to different variable values (e.g., thresholds, user preferences, etc.). As a matter of convenience, this disclosure does not always detail where the variables are stored or how they are retrieved. In such instances, it may be assumed that the variables are stored on a storage device accessible by the component via an API or other program communication method. Similarly, the variables may be assumed to have a default values should a specific value not be described. Described systems and methods may provide a user interface for an end-user or administrator to edit the variable values in some instances.

A common way to share documents is for a user to email the document to a number of recipients. This may be the case if the user is using a document authoring application locally on the user's computing device (e.g., laptop, tablet, etc.). Thus, the document may not be readily accessible by other users absent the e-mail.

The user may use a file hosting service that permits the user to backup and sync documents created on the user's computing device to an external storage device and other devices of the user (e.g., MICROSOFT ONEDRIVE®, GOOGLE DRIVE®). In various examples, collection of files that are stored with the file hosting service are referred to as a shared drive. The shared drive may be replicated on the file hosting service and any devices the user chooses.

The user may also use a document authoring application that has local and network-based user interfaces. For example, the user may use a native version of the application executing on the user's laptop to create a document. Then, a web-based version of the application may be used to edit the same document. In order to keep the document in sync, the application may use the shared drive.

In various examples, the shared drive may be part of a software as a service (SaaS) suite (e.g., MICROSOFT OFFICE 365® or GOOGLE G SUITE®) that includes a number of document authoring applications. The suite of applications and shared drive may use a common login identification—such as an e-mail address. In various examples, the software suite may be hosted on a cloud platform (e.g., MICROSOFT AZURE® or AMAZON EC2®) using shared computing infrastructure. A document authoring application may be contrasted with a content viewing only application. The latter may view content created by an authoring application, but may not be able to create or edit new documents. For example, a photo editing application may be an authoring application whereas a photo viewing application may not be.

The user may share files from the shared drive in a variety of manners. For example, the file hosting service may generate a link, such as Uniform Resource Locator (URL), which the user may share with contacts (e.g., other users) of the user. In some examples, the user may set permissions for a file to allow collaboration with other users of the software suite. In such examples, the shared file may appear in the shared drive of the collaborators.

One problem that arises in sharing files is the lack of visibility into what happens once they are shared. This is especially true when using user interfaces that exist within a document authoring application. For example, the application may show files that are on the user's shared drive, but not show what files have been shared. Similarly, there may be no displayed metrics on how many people have viewed the file in total or how many unique views there have been. If a user knew this information, the user may choose to review the most commonly viewed documents for errors or may choose to share a file which the user mistakenly thought was already shared. Another problem may be that the user does not know with whom to share a document.

Furthermore, display devices are inherently limited in the amount of information they can display. Accordingly, to efficiently use the display area, novel user interfaces that use document view specific criteria may be used to show the potentially most relevant documents to the user and most likely contacts to share the documents with.

The various systems described herein implement metric gathering and displaying within authoring applications. A user may view the user's profile within the application and see the top (e.g., most viewed) shared documents. Additionally, the systems may include suggested contacts to share each document with based on recent communication signals from the user to the user's contacts.

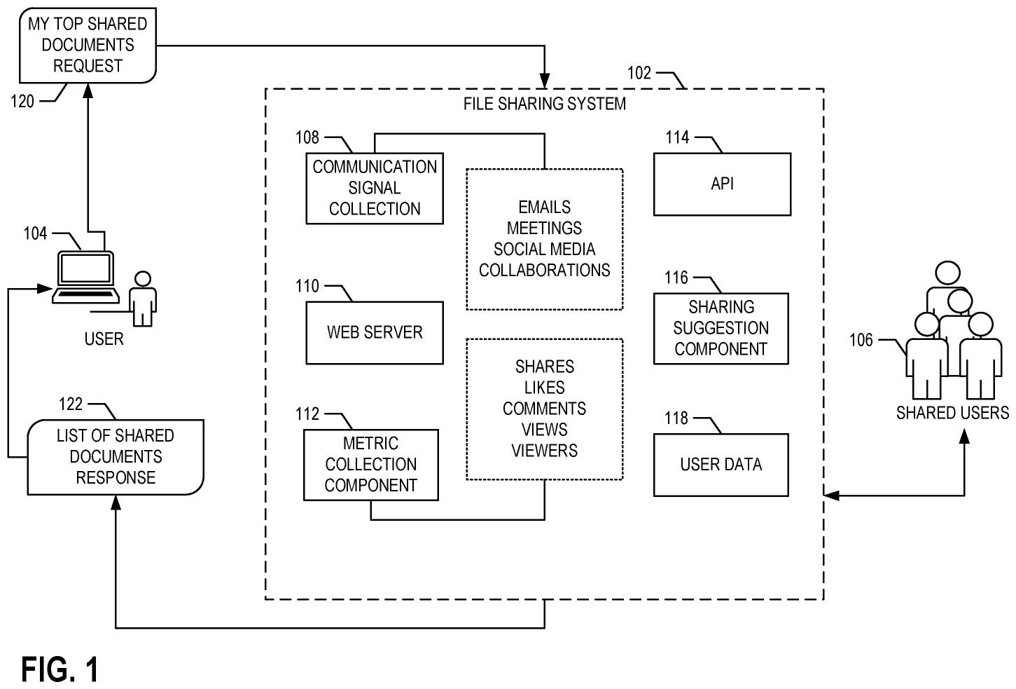

FIG. 1 is a schematic diagram illustrating file sharing system 102, in various examples. File sharing system 102 is illustrated as including communication signal collection 108, web server 110, metric collection component 112, application programming interface (API) 114, sharing suggestion component 116, and user data 118. User 104 may communicate request 120 to file sharing system 102 to obtain the top shared documents of the user. File sharing system 102 may issue response 122 with the list of shared documents—for example, those documents shared with at least one of shared users 106.

For illustration purposes, file sharing system 102 is illustrated as set of separate components (e.g., communication signal collection 108, metric collection component 112, etc.). However, the functionality of multiple, individual components may be performed by a single component. A component may represent computer program code that is executable by a processing unit (e.g., a core of a general-purpose computer processor, a graphical processing unit, an application specific integrated circuit, etc.) The program code may be stored on a storage device and loaded into a memory of the processing unit for execution. Portions of the program code may be executed in parallel across multiple processing units. Execution of the code may be performed on a single device or distributed across multiple devices.

In various examples, file sharing system 102 is part of a larger group of systems providing functionality to file sharing system 102. The functionality may include e-mail services, calendar services, etc. For convenience, however, portions of this functionality is presented as being part of file sharing system 102. For example, communication signal collection 108 may be part of an e-mail server that exists separate from file sharing system 102. In such instances, API calls may be made from file sharing system 102 to the e-mail server to retrieve the signals. In various examples, program code of file sharing system 102 and other system are executed on a cloud platform (e.g., MICROSOFT AZURE® or AMAZON EC2®) using shared computing infrastructure.

In various examples, the file sharing system 102, user 104, and shared users 106, may communicate via one or more networks (not illustrated). A network may include local-area networks (LAN), wide-area networks (WAN), wireless networks (e.g., 802.11 or cellular network), the Public Switched Telephone Network (PSTN) network, ad hoc networks, cellular, personal area networks or peer-to-peer (e.g., Bluetooth®, Wi-Fi Direct), or other combinations or permutations of network protocols and network types. A network may include a single local area network (LAN) or wide-area network (WAN), or combinations of LAN's or WAN's, such as the Internet.

In various examples consider that user 104 communicates with file sharing system 102 using a client device. Client devices may include, but are not limited to, a smartphone, tablet, laptop, multi-processor system, microprocessor-based or programmable consumer electronics, game console, set-top box, or any other device that a user utilizes to communicate over a network. In example embodiments, the client devices comprise a display module (not shown) to display information (e.g., in the form of specially configured user interfaces). In some embodiments, the client devices comprise one or more of a touch screen, camera, keyboard, microphone, and Global Positioning System (GPS) device.

File sharing system 102 may provide shared drive services to a number of users. Although illustrated as a single system, multiple instance of file sharing system 102 may be used to provide services to multiple users. Using multiple instances may provide a number of benefits. For example, if one instance of the system is attacked, or otherwise has network degradation, only those users which are shared on that instance may be impacted.

User data 118 may store the documents (also referred to as files) that are part of a user's shared drive. A document may be stored on the shared drive and not shared with other users. User data 118 may identify whether or not a document has been shared, and with which users (e.g., contacts of the user) a document is shared. In various examples, user data 118 includes a list of documents that are stored in the shared drive of a user. The list may include a title of the document, modification date, etc.

File sharing system 102 may use or define one or more application programming interfaces (API) such as API 114. An API provides a method for computing processes or systems to exchange data. A web-based API, such may be defined by file sharing system 102 and accessed web server 110 may permit users to upload and download documents and view their top shared documents with file sharing system 102.

Web server 110 may be configured to serve data in the form of webpages, web applications, data packages from file sharing system 102 to user 104 and shared users 106. Although generally discussed in the context of delivering webpages via the Hypertext Transfer Protocol (HTTP), other network protocols may be utilized by web servers 110 (e.g., File Transfer Protocol, Telnet, Secure Shell, etc.) A user may enter in a uniform resource identifier (URI) into a network browser (e.g., the INTERNET EXPLORER® web browser by Microsoft Corporation or SAFARI® web browser by Apple Inc.) that corresponds to the logical location (e.g., an Internet Protocol address) of one or more pages served by web server 110. In response, web server 110 may transmit a web page that is rendered on a display device of user 104. For example, web server 110 may display a web page that shows a listing of documents stored by file sharing system 102 for the user.

A user may authenticate to file sharing system 102 in a number of ways. For example, user 104 may enter in user credentials to a document authoring application on a client device. The application may be hosted on the client device or served via a web application by web server 110, for example. A token that indicates the user is authenticated may be passed to file sharing system 102 to enable access to user data 118. In an example, web server 110 presents a login page for the user to enter the user's credentials (e.g., e-mail address and password).

Communication signal collection 108 may monitor and analyze communication patterns between user 104 and other users. The content of any monitored communications may be excluded from communication signal collection 108. Signal sources may include, but are not limited to, emails, meeting accepted, meetings declined, social media posts, document collaborations, messaging, call logs, etc. As indicated, file sharing system 102 may be part of a larger suite of services provided to the user such as e-mail, calendar, and contact services. Accordingly, communication signal collection 108 may have already have authorized access to these services.

Consider that user 104 has a contact, Michael. Communication signal collection 108 may determine how many e-mails Michael and user 104 have exchanged over a period of time (e.g., the past 30 days). Communication signal collection 108 may further determine whether or not the emails were opened. An opened email may be a stronger signal that user 104 and Michael are closer colleagues than a contact who sends user 104 fifty unopened e-mails. Similarly, an indication that Michael and user 104 attended a meeting together may be a relatively stronger signal that Michael and user 104 work close together.

Accordingly, communication signal collection 108 may collect and store signals for user 104 in relation to other users of file sharing system 102. The signal data may be used by sharing suggestion component 116 to determine a set of suggested sharing contacts for a document, as discussed further herein.

Metric collection component 112 may collect and store attention metrics on documents stored by file sharing system 102. For example, each time a document is shared, liked, commented on, opened, etc., metric collection component 112 may update a data entry for the document. The entry may include date information on when the attending metric occurred and by whom.

Sharing suggestion component 116 may use a model to determine, for a given document, suggested contacts of user 104 to share the document with. The model be a weighted component model, machine learning model, etc. One or more of the signals collected by communication signal collection 108 may be input, for each potential sharing contact, into the model to calculate a relevancy score. For example, the score may be calculated using a formula such as:

(0.25)(Number of e-mails sent to contact)+15(Percentage of e-mails opened from contact)+20(Number of meetings attended with contact)+30(number of documents collaborating with contact)

The weights and signals above are merely examples and other weights and signals may be used without departing from the scope of this disclosure. A user may be considered collaborating with a contact if user data 118 indicates the contact—for example, using the user identification of the contact—has write access to the document.

Data used in file sharing system 102 may be organized and stored in a variety of manners such as in, but not limited to, a relational database (e.g., SQL), non-relational database (NoSQL), a flat file database, object model, document details model, graph database, shared ledger (e.g., blockchain), or a file system hierarchy. The data may be may be stored one or more storage devices (e.g., a hard disk, random access memory (RAM), etc.). The storage devices may be in standalone arrays, part of one or more servers, and may be located in one or more geographic areas as part or shared computing infrastructure.

Various security measures may be used to protect data at rest and in transmit to file sharing system 102. For example, APIs may use tokens or API keys to ensure only authorized parties may retrieve data from file sharing system 102. Additionally, data transmitted over a network may use a cryptographic protocol, such Secure Socket Layer (SSL) or Transport Layer Security (TLS). As a further security precaution, the transmitted data itself may be encrypted, separately from the SSL or TLS encryption. Public-key infrastructure (PKI) may be leveraged for SSL/TLS as well as the separate data encryption.

As an additional privacy precaution, users may be provided an interface (e.g., via web server 110) to see data that has been collected by file sharing system 102. The user may have the option of deleting some or all of the data. Furthermore, the user may set a time for expiration of the data. In various examples, users may have to opt-in to data collection (e.g., signal collection) before data may be collected by file sharing system 102 for suggesting contacts. Periodically, the user may be reminded that file sharing system 102 is using this data.

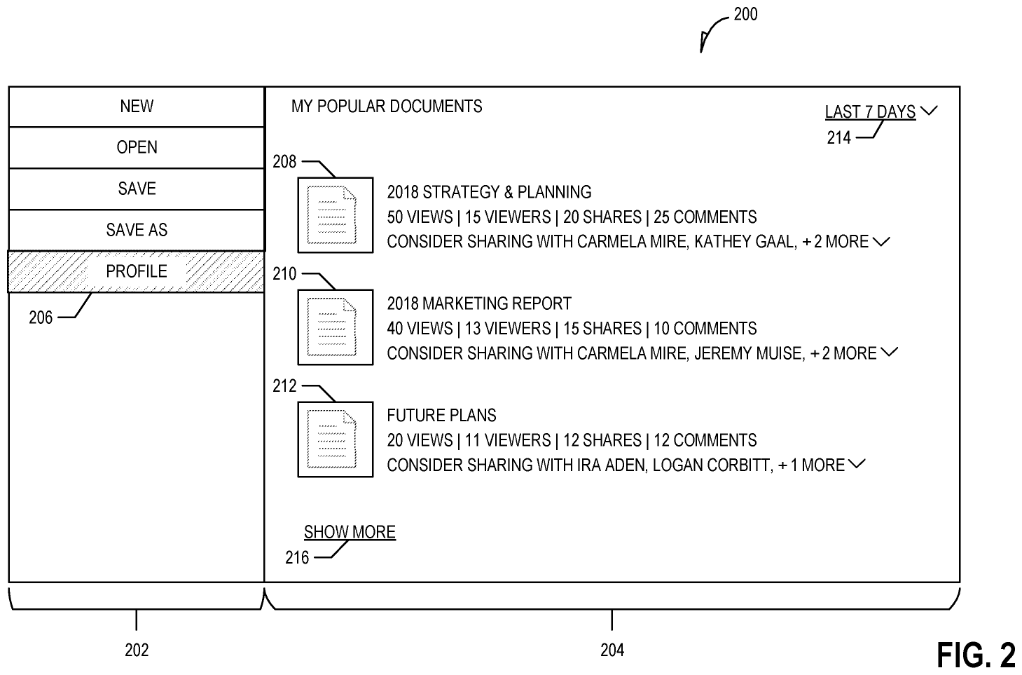

FIG. 2 is a diagram illustrating a user interface 200 of a document authoring application, according to various examples. User interface 200 is illustrated as including option interface pane 202 and document details pane 204. Option interface pane 202 presents a series of options including profile option 206. Document details pane 204 is shown as including document 208, document 210, document 212, period filter 214, and show more element 216.

The document authoring application may be a word processing application in an example Users may authenticate themselves to the authoring application by entering in an e-mail address and password (not shown).

Option interface pane 202 may present application options with respect to document creation, opening, and profile information. In FIG. 2, profile option 206 has been selected. Document details pane 204 may be presented when profile option 206 is selected. If “New” is selected, document details pane 204 may instead be a document creation pane, in various examples.

The information shown in document details pane 204 may be in response to a query made by the authoring application to a system such as file sharing system 102. The query may include the identification of the user logged into the application and the time period selected by period filter 214. Document details pane 204 shows three documents that may have been returned by the query. Show more element 216 may be activated (e.g., clicked) by the user to show additional documents.

As illustrated, documents 208, 210, and 212 are sorted according to total views. In various examples, a user interface element is presented to allow the user to sort by other attention metrics (e.g., unique viewers, shares, etc.)

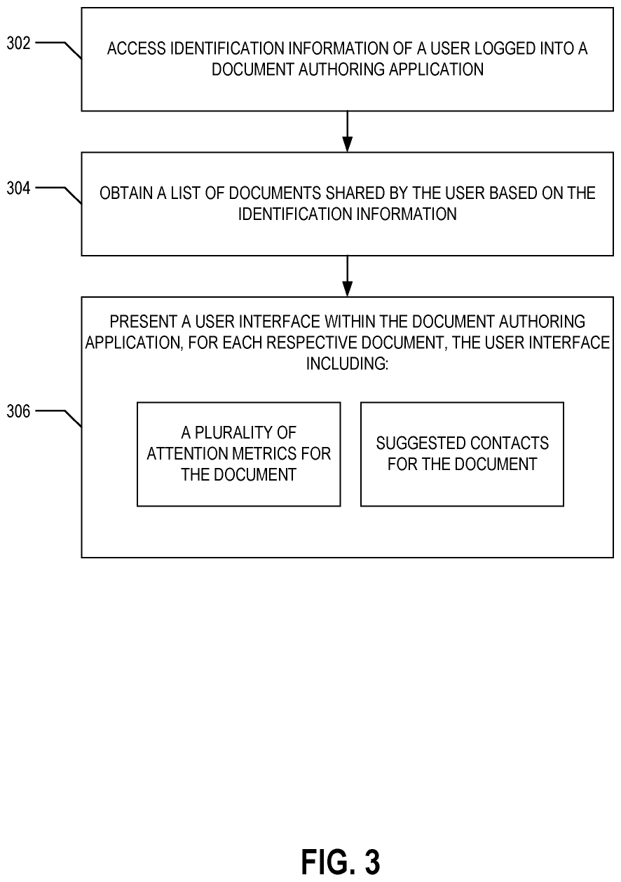

FIG. 3 is a flowchart representation of a method to present a user interface displaying attention metrics, according to various examples. The method may be embodied in a set of instructions stored in at least one computer-readable storage device of a computing device(s). A computer-readable storage device excludes transitory signals. In contrast, a signal-bearing medium may include such transitory signals. The computing device(s) may have one or more processors that execute the set of instructions to configure the one or more processors to perform the operations illustrated in FIG. 3. The one or more processors may instruct other component of the computing device(s) to carry out the set of instructions. For example, the computing device may instruct a network device to transmit data to another computing device or the computing device may provide data over a display interface to present a user interface. In some examples, performance of the method may be split across multiple computing devices using a shared computing infrastructure.

At operation 302, in various examples, identification information of a user logged into a document authoring application is accessed. For example, the authoring application may have a token, e-mail address, etc., associated with the user of the authoring application.

At operation 304, in various examples, a list of documents shared by the user based on the identification information is obtained. Obtaining may include transmitting a request, via an API, to a system external to the document authoring application. The API call may include the identification information.

In some examples, the API call may include a time period. The time period may be determined by a user selecting the period in a drop-down menu in a user interface pane of the authoring application. For example, a period of the last seven days may be selected. The time period may establish the time period for which to include attention metrics.

At operation 306, in various examples, a user interface may be presented within the document authoring application. In various examples, the user interface is arranged in a plurality of interface panes. The first pane may present menu options to create and save documents in the document authoring application. The second pane may present attention metrics and suggested set of contacts with which to share the respective document for each respective document in the list of documents. Attention metrics may include, but are not limited total viewers, unique viewers, shares of the respective document, and comments on the respective document. The attention metrics and suggested set of contacts may be received in response to the API request for the list of documents.

The number of contacts in the set of contacts may be limited to a defined number (e.g., five), with a user interface presenting an option to see more suggestions. Each contact may appear as a picture of the contact, as the contact's initials within a circle, the contact's name, etc., without departing from the scope of this disclosure.

In various examples, the second user interface pane presents a time period selection element. When the user selects a new time period, the plurality of attention metrics may be updated for each presented document. Updating may include transmitting a subsequent API call to the external system (e.g., file sharing system 102). In some examples, a different set of documents may be included in the list based on the update. For example, consider that the time period was initially 30 days, but was updated to 7 days. In such as a scenario, the most viewed document of the past 30 days may not have been viewed at all in the past 7 days. Accordingly, the top document may no longer appear in the list depending on the views of other documents in the past seven days.

In various examples, a contact of the set of contacts for the respective document may be selected by the user. For example, the user may click on one of the suggested contacts. A message may appear in the user interface to confirm that the user wishes to share the document with the selected contact. Upon confirmation, the contact may be enabled to view the respective document. For example, a message be transmitted to file sharing system 102 to update permission of the document to permit the contact to view or modify the document. In some examples, a notification message is transmitted to the contact about the new share of the document.

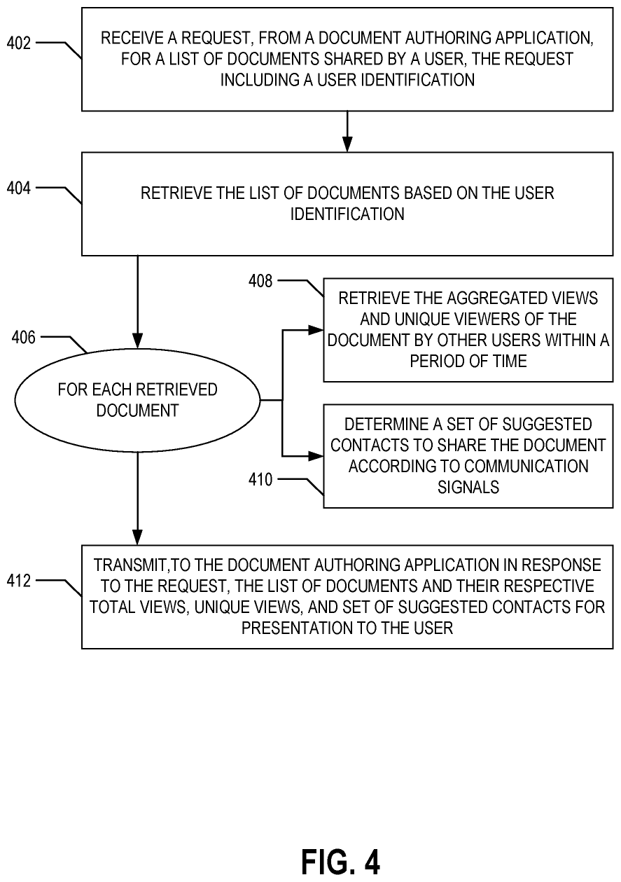

FIG. 4 is a flowchart representation of a method to retrieve attention metrics and suggested sharing contacts for a document, according to various examples. The method may be embodied in a set of instructions stored in at least one computer-readable storage device of a computing device(s). A computer-readable storage device excludes transitory signals. In contrast, a signal-bearing medium may include such transitory signals. The computing device(s) may have one or more processors that execute the set of instructions to configure the one or more processors to perform the operations illustrated in FIG. 4. The one or more processors may instruct other component of the computing device(s) to carry out the set of instructions. For example, the computing device may instruct a network device to transmit data to another computing device or the computing device may provide data over a display interface to present a user interface. In some examples, performance of the method may be split across multiple computing devices using a shared computing infrastructure.

At operation 402, in various examples, a request may be received, from a document authoring application, for a list of documents shared by a user. The request may be formatted as an API call and may include a user identification. The user identification may be a token. The request may be received at a system that provides alone, or in combination with other systems, file backup, sync, and sharing services (e.g., file sharing system 102).

The system may include a database that maintains information on which files have been shared (and with which contacts), who has viewed shared documents, etc., according to the user identification. Accordingly, at operation 404 the list of documents may be received based on the user identification. The list may include the title of each document.

Furthermore, for each respective document in the list (406) a number of operations may be performed. At operation 408, an aggregation of views and unique viewers of by other users for the respective document may be retrieved for a period of time. The aggregated views (e.g., total) and unique views may be considered attention metrics. A document may be considered viewed when opened. A subsequent opening of the document by the same users would be considered an additional view. The period of time may be determined according to the request received at 402. The attention metrics may be retrieved by querying database that is maintained at the same system that received the request. The attention metrics may be retrieved by transmitting a call to another system with the user identification and the period of time. For example, a call may be made to request the number of viewers in the past seven days for each shared document the user. Other attention metrics may include the number of comments, the number of re-shares, the number of times the document has been used as a starting point for another document, the number of positive indications (e.g. likes), among others.

At operation 410, in various examples, a set of suggested contacts to share the respective document with is determined according to communication signals between the suggested contacts and the user. Determining may include calculating a relevancy score, for a potential contact to include in the set of contacts, in relation to the respective document. The relevancy score may be based on the communication signals between the potential contact and the user. In various examples, communications that made outside the period of time are excluded for determining the relevancy score.

Communication signals may include the number and frequency of e-mails exchanged between the user and potential contact, meetings between the potential contact and user, phone calls made between the potential contact and user (through a messaging application, VoIP, etc.), collaboration on document creation/editing between the contact and user, following the potential contact on social media or within a content management system, indicating an affirmation (e.g., a rating, like, etc.) of the potential users work by the users or the reverse, presentations performed with the potential contact, and having content similar to the potential user (e.g., using content similarity algorithms), among others.

In addition to the raw number of communications, a qualitative assessment may be made for each communication. For example, an e-mail may be sent by the potential contact, but not opened by the user may be of lower value than an opened e-mail, which itself may be a relatively lower value than the user sending a reply. The qualitative assessment may also include whether or not the communication was relevant to the respective document. For example, the e-mail's subject or meeting agenda may include the title of the respective document indicating relevance.

The total number and qualitative nature of the communications may be input a model (e.g., a weighted component score, etc.) to determine the relevancy score. The relevancy score may be a standardized probability rating from zero (not relevant) to one (highly relevant) with regards to the respective document and potential contact. In various examples, the score is unbounded. The weights of each component may be stored as part of the model and may be modified by an administrator user.

In various examples, if a potential contact has viewed the document since the last modified date of the respective document, the potential contact is excluded from the set of potential contacts.

At operation 412, in various examples, the list of documents and their respective total views, unique views, and set of suggested contacts are transmitted to the document authoring application for presentation to the user. The transmission may also include other attention metrics for the list of documents. The transmission may also include a ranking of the set of potential contacts by relevancy score for each respective document in the list of documents. Thus, when presenting the set of suggested contacts for a document, the most relevant contacts may be presented first in the document authoring application. In some examples, a limited set of the suggested contacts are transmitted (e.g., the top five based on relevancy score).

### Example Computer System

Embodiments described herein may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

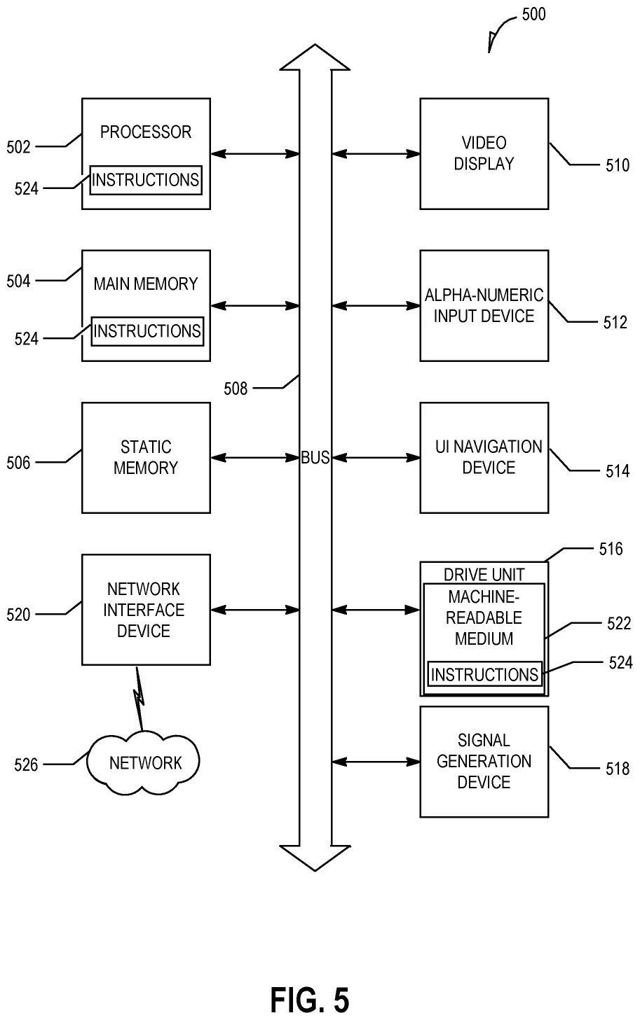

FIG. 5 is a block diagram illustrating a machine in the example form of a computer system 500, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 may further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or another sensor.

The storage device 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 506, and/or within the processor 502 during execution thereof by the computer system 500, with the main memory 504, static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. A computer-readable storage device is a machine-readable medium that excludes transitory signals.

The instructions 524 may further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

What is claimed is:

1. A method comprising:
receiving a request, from a document authoring application, for a list of documents shared by a user, the request including a user identification;
retrieving the list of documents based on the user identification;
for each respective document in the list of documents;
retrieving an aggregation of views of the respective document by other users within a period of time;
retrieving a number of unique viewers of the respective document within the period of time; and
determining a set of suggested contacts to share the respective document with according to communication signals between the suggested contacts and the user; and
transmitting, to the document authoring application in response to the request, the list of documents and their respective total views, unique views, and set of suggested contacts for presentation to the user.

2. The method of 1, wherein determining the set of suggested contacts for a respective document includes excluding contacts that have already viewed the respective document since a last modified date of the respective document.

3. The method of 1, wherein determining the set of suggested contacts for a respective document includes:
calculating a relevancy score, for a potential contact to include in the set of contacts, in relation to the respective document based on the communication signals between the potential contact and the use; and
ranking the set of suggested contacts according to the relevancy score.

4. The method of 3, wherein the communication signals includes a number of documents the potential contact and the user have collaborated on within the period of time.

5. The method of 3 wherein the relevancy score is based on a communication frequency between the potential contact and the user.

6. The method of 1, further comprising:
determining a number of shares by the other users of the respective document; and
transmitting, to the computing device, the number of shares for presentation to the user.

7. The method claim 1, wherein the period of time is included in the request.

8. A computer-readable storage device comprising instructions, which when executed by at least one processor, configure the at least one processor to perform operations comprising:
accessing identification information of a user logged into a document authoring application;
obtaining a list of documents shared by the user based on the identification information; and
presenting a user interface within the document authoring application, the user interface including, for each respective document, in the list of documents:
a plurality of attention metrics for the respective document; and
a suggested set of contacts with which to share the respective document.

9. The computer-readable storage device of claim 8, the operations further comprising:
receiving a selection of a contact of the set of contacts for the respective document;
in response to receiving the selection, enabling the contact to view the respective document.

10. The computer-readable storage device of 8, wherein the attention metrics are selected from a group comprising: total viewers, unique viewers, shares of the respective document, and comments on the respective document.

11. The computer-readable storage device of 8, wherein the user interface is arranged in a plurality of interface panes, the first pane presenting menu options to create documents in the document authoring application, and the second pane presenting the attention metrics and suggested set of contacts.

12. The computer-readable storage device of claim 11, the operations further comprising:
receiving a selection of a time period in the user interface; and
for each respective document in the list of documents:
updating the plurality of attention metrics for the respective document based on the selection of the time period.

13. The computer-readable storage device of claim 8, wherein the operations further comprise:
limiting the display of the set suggested contacts to a defined number of contacts.

14. A system comprising:
at least one processor;
a storage device comprising instructions, which when executed by the at least one processor, configure the at least one processor to perform operations comprising:
receiving a request, from a document authoring application, for a list of documents shared by a user, the request including a user identification;
retrieving the list of documents based on the user identification;
for each respective document in the list of documents;
retrieving an aggregation of views of the respective document by other users within a period of time;
retrieving a number of unique viewers of the respective document within the period of time; and
determining a set of suggested contacts to share the respective document with according to communication signals between the suggested contacts and the user; and
transmitting, to the document authoring application in response to the request, the list of documents and their respective total views, unique views, and set of suggested contacts for presentation to the user.

15. The system of 14, wherein determining the set of suggested contacts for a respective document includes excluding contacts that have already viewed the respective document since a last modified date of the respective document.

16. The system of 14, wherein determining the set of suggested contacts for a respective document includes:
calculating a relevancy score, for a potential contact to include in the set of contacts, in relation to the respective document based on the communication signals between the potential contact and the use; and
ranking the set of suggested contacts according to the relevancy score.

17. The system of 16, wherein the communication signals includes a number of documents the potential contact and the user have collaborated on within the period of time.

18. The system of 16, wherein the relevancy score is based on a communication frequency between the potential contact and the user.

19. The system of 14, the storage device further comprising instructions, which when executed by the at least one processor, configure the at least one processor to perform operations comprising:
determining a number of shares by the other users of the respective document; and
transmitting, to the computing device, the number of shares for presentation to the user.

20. The method claim 14, wherein the period of time is included in the request.
